(19) United States
(12) Patent Application Publication
(10) Pub. No.: US 2007/0223984 A1
(43) Pub. Date: Sep. 27, 2007

(54) Portable data-entry device

(75) Inventor: Michael Schweers, Meerbusch (DE)

Correspondence Address: K.F. ROSS P.C., 5683 RIVERDALE AVENUE, SUITE 203 BOX 900, BRONX, NY, 10471-0900, US

(73) Assignee: Schweers Informationstechnologie GmbH

(21) Appl. No.: 11/726,132

(22) Filed: Mar. 21, 2007

(30) Foreign Application Priority Data
Mar. 22, 2006 (EP) 06005852.6

(51) Int. Cl. B41J 5/00

(52) U.S. Cl. 400/486

(57) ABSTRACT

A mobile hand-held data-processing device has a housing that has a front and a back and contains a data-processing unit and whose front contains both an input unit for data input and/or operator control of the hand-held data-processing device and a readout unit, in the form of a display, for outputting picture and/or processing and/or control information, the input unit being in the form of a keyboard having a keyboard layout with customary QWERTZ or QWERTY key columns. To allow rapid text input with as few errors as possible by the user of the device, the customary QWERTZ or QWERTY key columns are intended to be oriented vertically when the mobile hand-held data-processing device is being handled normally, and the orientation of the key labeling on the individual keys is intended to be provided horizontally in line with the horizontally readable display readout on the readout unit.

### FIELD OF THE INVENTION

The present invention relates to date-processing device. More particularly this invention concerns a portable data-entry device with a full alphanumeric keyboard.

### BACKGROUND OF THE INVENTION

The invention relates to a mobile hand-held data-processing device, particularly for handling infringements against regulations or the like that have been detected by an operator, such as for recording violations of regulations, for example in the case of infringements against traffic regulations when monitoring parked and/or moving vehicles, having a housing that has a front and a back and contains a data-processing unit and whose front contains both an input unit for data input and/or operator control of the hand-held data-processing device and a readout unit, in the form of a display, for outputting picture and/or processing and/or control information, the input unit being in the form of a keyboard having a keyboard layout with customary QWERTZ or QWERTY key columns.

Such mobile hand-held data-processing devices are known from practice and may be in a wide variety of embodiments. In this case, keyboards with a customary column QWERTZ or QWERTY layout are provided in minimalized form, the QWERTZ or QWERTY key columns being oriented horizontally when the mobile hand-held data-processing device is being handled normally, and the key labeling on the individual keys likewise being provided horizontally in line with the horizontally readable display readout on the readout unit.

A drawback in this context is that the limited dimensions of the mobile hand-held data-processing device and the vertically oriented design of the device on account of the required mobility mean that the space for the keyboard is very narrow and the narrowness in space therefore means very small keys. These are firstly inconvenient to operate and, on account of the likewise very small labeling, also cannot be used with the requisite reliability for rapidly inputting relatively long texts.

In addition, the small amount of space means that there are frequently no separate digit keys provided, which means that it is necessary for keys to have dual assignments with an additional shift key or shift function. With mixed input of letters and digits, as is the case with vehicle indexes or case numbers, for example, such dual assignment is rather a nuisance and requires complex and time-consuming changeover between the various keyboard modes, which often contributes to incorrect inputs.

### OBJECT OF THE INVENTION

It is an object of the invention to avoid the aforementioned drawbacks and to specify a mobile hand-held data-processing device of the aforementioned type that allows rapid text input with as few errors as possible by the user of the device.

### SUMMARY OF THE INVENTION

This object is achieved in that the customary QWERTZ or QWERTY key columns (QWERTZ . . . , ASDF . . . , YXCV . . . ) are oriented vertically when the mobile hand-held data-processing device is being handled normally, and the orientation of the key labeling on the individual keys is provided horizontally in line with the horizontally readable display readout on the readout unit. As a result, the vertical arrangement of the key columns as neighboring columns of the same device width means that a much greater key area per individual key is possible, so that both the hitting accuracy and the labeling size and hence legibility are significantly improved. This simplifies operator control and reduces incorrect inputs.

The layout of the keyboard may be provided either with a 90° rotation to the right or with a 90° rotation to the left in comparison with a customary keyboard in transverse orientation. It is also possible for additional columns and/or rows, e.g. for numbers and/or function keys, to be provided as required.

In this case, the keys in the customary QWERTZ or QWERTY key columns (QWERTZ . . . , ASDF . . . , YXCV . . . ) may be produced as standard with a respective matching form, so that a standard appearance results in a particularly tidy user interface and it is possible for operator control to occur more easily without precise inspection.

Advantageously, the customary QWERTZ or QWERTY key columns (QWERTZ . . . , ASDF . . . , YXCV . . . ) may be provided vertically below the display readout when the mobile hand-held data-processing device is being handled normally, so that when the mobile hand-held data-processing device is oriented vertically it is possible for keys situated horizontally next to one another in the different key columns to be operated merely by means of lateral, i.e. horizontal displacement of the relevant finger.

In line with the invention, the customary QWERTZ or QWERTY key columns (QWERTZ . . . , ASDF . . . , YXCV . . . ) may have no vertical lengthwise offset from one another when the mobile hand-held data-processing device is being handled normally, and the individual keys in the key columns may be provided in rows next to one another (e.g. QAY, WSX, EDC, etc.).

Alternatively, the customary QWERTZ or QWERTY key columns (QWERTZ . . . , ASDF . . . , YXCV . . . ) may have a lengthwise offset from one another, and the individual keys in the key columns may be provided in rows next to one another (Q, WA, ESY, RDX, etc.), so that the individual keys are arranged as similarly as possible to a customary typewriter or computer keyboard, with an offset of around a whole key width being provided instead of half a key width. In this case, free spaces resulting in this respect at the end of a key column may be filled by additional keys with other function assignments or the like in order to achieve an overall rectangular keyboard arrangement.

Preferably, the keyboard may be of mechanical design, so that reliable operator control impossible as a result of a good action point or the like and the keyboard has a high level of mechanical stability under load.

Alternatively, the keyboard may be in the form of a touch-sensitive panel, so that the risk of technical faults is reduced by avoiding mechanical components.

The keyboard may also be in the form of a touchscreen, so that firstly the keyboard layout can be adapted as desired and secondly the area taken up by the keyboard is available for other applications, e.g. the display of separate data or the like, when the keyboard is not in use.

In this case, the keyboard in the form of a touchscreen may be in the form of a unit having the readout unit, which is a component-related simplification.

In one preferred embodiment of the invention, the display readout on the readout unit may be able to be read in a corresponding transverse orientation when the mobile hand-held data-processing device is held transversely, so that when the keyboard columns are arranged in line with those on a customary typewriter or computer keyboard the display can then be changed over to a readout view rotated through 90° to the left or the right as appropriate. In this case, the labeling of the keyboard is then twisted through 90° in principle and cannot be read as normal, but can nevertheless be operated in simple fashion.

To avoid this, the orientation of the key labeling may be provided by means of an interchangeable or reversible cover for a touch-sensitive panel in line with the transversely oriented (readable) display readout, so that it is possible to match the key labeling to the respective orientation in which the hand-held data-processing device is held.

It is also possible for the orientation of the key labeling to be provided by means of an appropriately adapted readout on the touchscreen in line with the transversely oriented readable display readout, so that it is possible for the key labeling to be automatically adapted in line with the orientation of the display readout on the readout unit.

### BRIEF DESCRIPTION OF THE DRAWING

The above and other objects, features, and advantages will become more readily apparent from the following description, reference being made to the accompanying drawing in which:

FIG. 1 is a view of a first embodiment of an inventive mobile hand-held data-processing device in a vertical orientation;

FIG. 2 shows the subject matter from FIG. 1 in a horizontal orientation;

FIG. 3 shows a second embodiment of an inventive mobile hand-held data-processing device;

FIG. 4 shows the subject matter from FIG. 3 in a horizontal orientation;

FIG. 5 shows the keyboard layout of an ordinary computer keyboard.

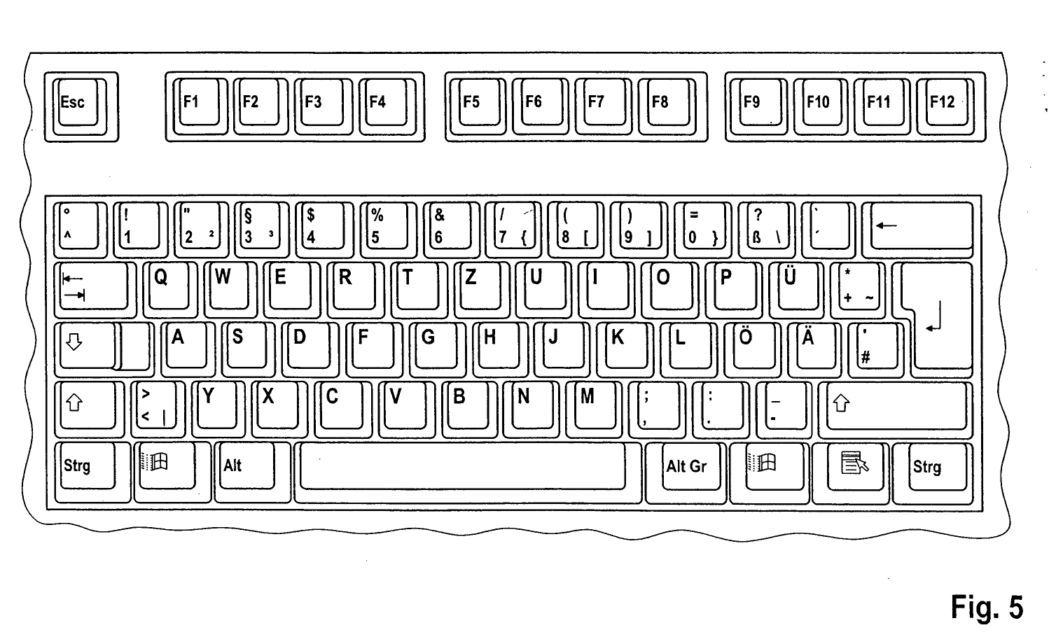

### SPECIFIC DESCRIPTION

In all figures, the same reference symbols are used for components that are the same or that are of the same type.

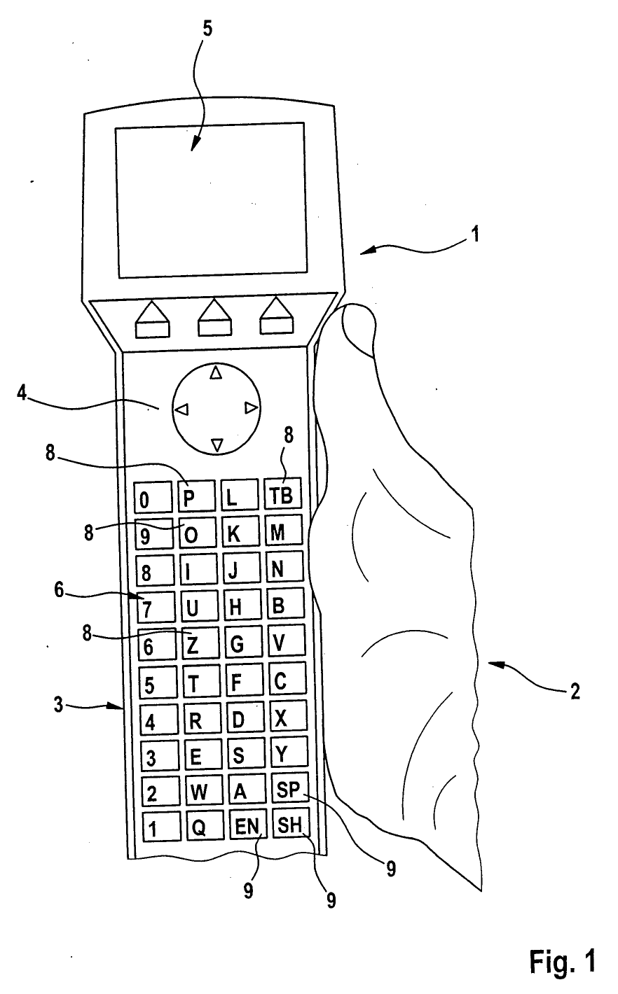

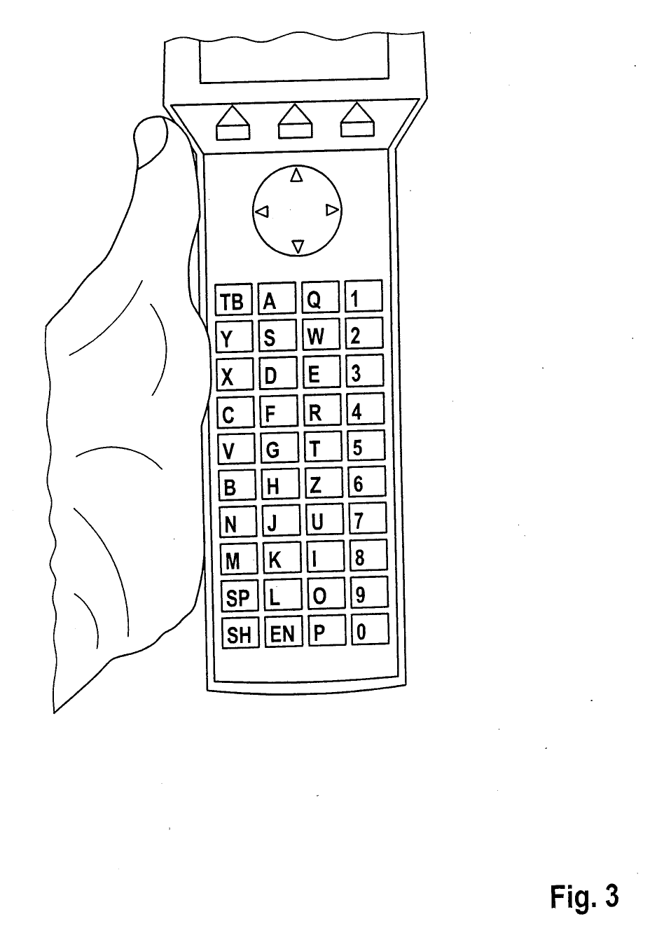

FIGS. 1 and 3 respectively show a mobile hand-held data-processing device 1 and the right or left hand of an operator 2, who is otherwise not shown in the drawing.

In this case, the respective hand-held data-processing device 1 has a housing 3 with a front 4 containing a readout unit 5 in the form of a display and an input unit 6. In this arrangement, the input unit 6 comprises a keyboard 7 with a multiplicity of keys 8 that are provided in columns arranged next to one another in the embodiment shown. The keyboard layout in this case is provided with a “QWERTZ or QWERTY” layout in line with a customary computer keyboard, where the customary key columns (QWERTZ . . . , ASDF . . . , YXCV . . . ) are oriented vertically when the hand-held data-processing device 1 is being handled normally, and the orientation of the key labeling on the individual keys 8 is provided horizontally in line with the horizontally readable display readout on the readout unit 5.

In this case, the individual keys 8 in the respective key columns are produced as standard with a respective matching form, at least in the respective key column, and the key columns are provided below the readout unit 5 when the hand-held data-processing device 1, which in this case has a vertical orientation, is being handled normally.

The key columns may be arranged next to one another in standard form, but in the embodiment shown there is a lengthwise offset between the individual QWERTZ or QWERTY key columns, with the free areas that result in this respect being occupied and filled by function keys 9.

In the embodiment shown, the keyboard 7 is not of mechanical design and is also not provided in the form of a touchscreen but rather is formed by a touch-sensitive panel.

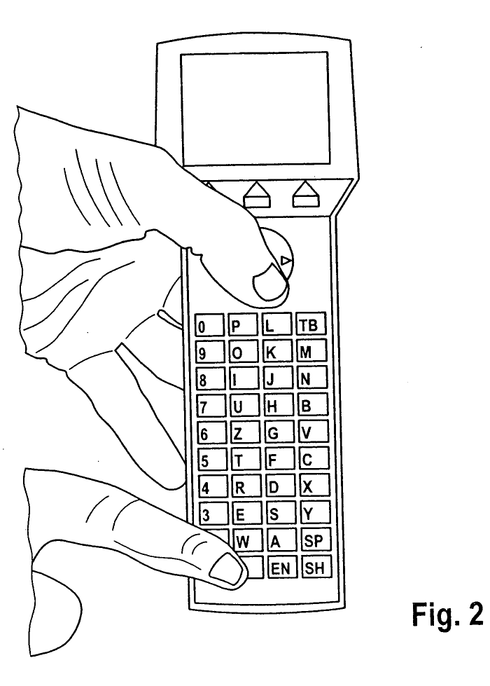

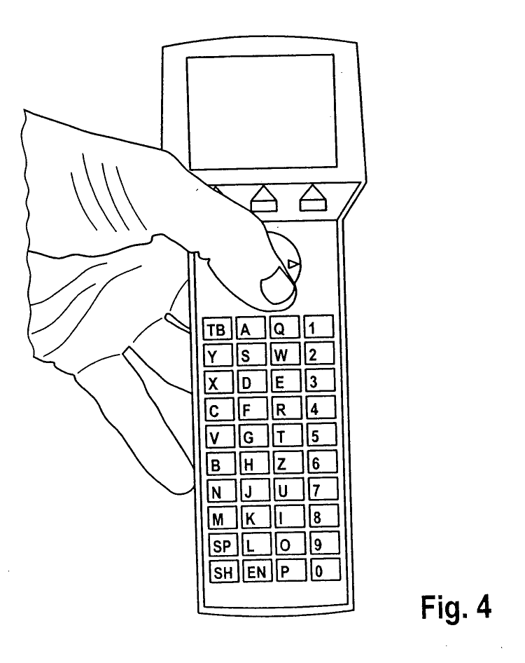

As can be seen in FIGS. 2 and 4, in this respect the key labeling is first of all twisted through 90° and hence cannot be read “as normal” when the mobile hand-held data-processing device 1 is held transversely. The display readout on the readout unit 5 can be changed over to a transverse view for the purpose of inputting a more complex text. This can be done automatically in the case of a touchscreen by identifying the orientation of the hand-held data-processing device 1, or else can be changed over by the operator 2 by operating a key or keys.

In the embodiment shown, the labeling on the individual keys 8 can be adapted as appropriate by virtue of an interchangeable or, in particular, reversible cover on the touch-sensitive panel of the input unit 6 without changing the keyboard layout.

1. A mobile hand-held data-processing device, particularly for handling infringements against regulations that have been detected by an operator, such as for recording violations of regulations, for example in the case of infringements against traffic regulations when monitoring parked and/or moving vehicles, comprising:
a housing having a front and a back;
a data-processing unit contained in the housing;
an input unit for data input and/or operator control of the hand-held data-processing device on the front;
a display on the front for outputting picture and/or processing and/or control information, the input unit being a keyboard having a keyboard layout with customary QWERTZ or QWERTY key columns, the customary QWERTZ or QWERTY key columns being oriented vertically when the mobile hand-held data-processing device is being handled normally, and the orientation of the key labeling on the individual keys being provided horizontally in line with the horizontally readable display readout on the readout unit.

2. The mobile hand-held data-processing device according to claim 1 wherein the keys in the customary QWERTZ or QWERTY key columns are produced as standard with a respective matching form.

3. The mobile hand-held data-processing device according to claim 1 wherein the customary QWERTZ or QWERTY key columns are provided vertically below the display readout when the mobile hand-held data-processing device is being handled normally.

4. The mobile hand-held data-processing device according to claim 1 wherein the customary QWERTZ or QWERTY key columns have no vertical lengthwise offset from one another when the mobile hand-held data-processing device is being handled normally, and the individual keys in the key columns are provided in rows next to one another.

5. The mobile hand-held data-processing device according to claim 1 wherein the customary QWERTZ or QWERTY key columns have a lengthwise offset from one another, and the individual keys in the key columns are provided in rows next to one another.

6. The mobile hand-held data-processing device according to claim 1 wherein the keyboard is of mechanical design.

7. The mobile hand-held data-processing device according to claim 1 wherein the keyboard is in the form of a touch-sensitive panel.

8. The mobile hand-held data-processing device according to claim 1 wherein the keyboard is in the form of a touchscreen.

9. The mobile hand-held data-processing device according to claim 8 wherein the keyboard in the form of a touchscreen is in the form of a unit having the readout unit.

10. The mobile hand-held data-processing device according to claim 1 wherein the display readout of the readout unit can be read in a corresponding transverse orientation when the mobile hand-held data-processing device is held transversely.

11. The mobile hand-held data-processing device according to claim 10 wherein the keyboard is in the form of a touch screen and the orientation of the key labeling is provided by means of an appropriately adapted readout on the touchscreen in line with the transversely oriented readable display readout.

12. The mobile hand-held data-processing device according to claim 10 wherein the keyboard is in the form of a touch-sensitive panel and the orientation of the key labeling is provided by means of an interchangeable or reversible cover for a touch-sensitive panel in line with the transversely oriented display readout.
